(19) United States
(12) Patent Application Publication
(10) Pub. No.: US 2026/0083602 A1
(43) Pub. Date: Mar. 26, 2026

(54) ARRANGEMENT FOR SHIFTING A WHEELCHAIR LIFT WITHIN A VEHICLE

(71) Applicant: Autolift S.r.l., Pegognaga (IT)

(72) Inventor: Marco GALLINGANI, Reggio Emilia (IT)

(73) Assignee: Autolift S.r.l., Pegognaga (IT)

(21) Appl. No.: 19/327,116

(22) Filed: Sep. 12, 2025

(30) Foreign Application Priority Data
Sep. 20, 2024 (EP) 24201585.7

(51) Int. Cl. A61G 3/06

(52) U.S. Cl. CPC A61G 3/067; A61G 3/062

(57) ABSTRACT

An arrangement (3) for shifting a wheelchair lift (2) within a vehicle includes a supporting plate (10) for supporting the wheelchair lift (2), at least one guiding rail (20a, 20b), and at least one sliding element (30a, 30b, 30c, 30d). The at least one sliding element (30a, 30b, 30c, 30d) is configured to be secured on the at least one guiding rail (20a, 20b) and to be movable along the at least one guiding rail (20a, 20b). The at least one sliding element (30a, 30b, 10 30c, 30d) is arranged on a bottom side of the supporting plate (10), the bottom side of the supporting plate (10) facing the at least one guiding rail (20a, 20b).

### CROSS REFERENCE TO RELATED APPLICATIONS

Applicant claims priority under 35 U.S.C. § 119 of European Application No. 24201585.7 filed Sep. 20, 2024, the disclosure of which is incorporated by reference.

### TECHNICAL FIELD

The disclosure relates to an arrangement for shifting a wheelchair lift within a vehicle, for example from a parking position away from an entrance area into the entrance area of the vehicle. The disclosure further relates to a shiftable lifting assembly for disabled persons comprising an arrangement for shifting a wheelchair lift within a vehicle.

### BACKGROUND

To enable disabled persons to be transported in vehicles and to make it easier for them to get in and out, lifting devices are used that are installed in the vehicles. These lifting devices include wheelchair lifts, for example. A wheelchair lift essentially comprises a platform for loading a wheelchair and a lifting device for raising and lowering the platform. The platform can be moved by the lifting device from a retracted/stowed position, in which the platform and the lifting device are folded together, to an entry position and a ground position, in which the platform is folded out.

In the ground position, a wheelchair can be moved from a surface outside the vehicle onto the platform in order to be lifted to the entry position at the floor level of the vehicle by the lifting device. At the floor level of the vehicle, the wheelchair can be moved from the platform into the interior of the vehicle. When the wheelchair is exiting the vehicle, the platform of the wheelchair lift moves in the opposite direction from the entry position at the floor level of the vehicle to the ground position outside the vehicle in order to unload the wheelchair.

A wheelchair lift is usually positioned in the entrance area of the vehicle, for example near a sliding door for entering the rear area of the vehicle. However, if the entrance to the vehicle is also used by non-disabled persons, a wheelchair lift that is firmly mounted in the entrance area of the vehicle prevents non-disabled persons from entering the vehicle.

There is a desire to provide an arrangement for shifting a wheelchair lift within a vehicle, with which the wheelchair lift can be easily moved into the entrance area of the vehicle if necessary and can then be moved back into a parking position outside the entrance area of the vehicle if the wheelchair lift is no longer being used.

Furthermore, there is a desire to provide a shiftable lifting assembly for disabled persons, with which a wheelchair lift can be displaced inside a vehicle from a parking position outside an entrance area of the vehicle into the entrance area of the vehicle when required and can be moved back into the parking position when not in use.

### SUMMARY

An arrangement for shifting a wheelchair lift within a vehicle which enables a wheelchair lift to be displaced within the vehicle in order for it to be moved from a parking position into an entrance area of the vehicle when required is provided according to one aspect of the invention.

According to an embodiment of the arrangement for shifting a wheelchair lift within a vehicle, the arrangement comprises a supporting plate for supporting the wheelchair lift, at least one guiding rail, and at least one sliding element. The at least one sliding element is configured to be secured on the at least one guiding rail and to be movable along the at least one guiding rail. The at least one sliding element is arranged on a bottom side of the supporting plate. The bottom side of the supporting plate faces the at least one guiding rail.

The arrangement for shifting a wheelchair lift within a vehicle makes it possible to move the supporting plate along the at least one guiding rail. The at least one sliding element acts as a carriage which is fixed under the supporting plate and slides on the at least one guiding rail. The at least one guiding rail and the at least one sliding element enable the supporting plate to move safely. If a wheelchair lift is mounted on the supporting plate, the wheelchair lift can thus be moved along the at least one guiding rail from a parking position to an entry/exit position.

The arrangement for shifting a wheelchair lift can be mounted, for example, in the rear part of a vehicle on the floor of the vehicle. This allows a wheelchair lift to be moved from the parking position being a position away from a side access door to the entry/exit position being a position near a boarding or entrance area or near the side access door of the vehicle if required. If the wheelchair is no longer required, the supporting plate with the wheelchair lift mounted on it is pushed back from the entry/exit position to the parking position so that the access to the vehicle is no longer blocked by the wheelchair lift.

According to a possible embodiment, the arrangement for shifting a wheelchair lift comprises a mounting plate that is configured to be mounted with a bottom side to a floor of the vehicle. The mounting plate can be bolted to the vehicle floor, for example. According to another embodiment, the mounting plate can be glued to the vehicle floor. The last type of attachment makes it possible to use the arrangement for shifting a wheelchair lift in electrically powered vehicles, for example, in which bolting is difficult or even impossible due to the vehicle components provided under the floor, in particular a car battery.

The at least one guiding rail is mounted to a top side of the mounting plate. As all of the components of the arrangement for shifting a wheelchair lift are attached to the mounting plate as a support, it is not necessary to attach and align the various components of the arrangement individually on the vehicle floor, especially if several guiding rails are present.

According to a possible embodiment of the arrangement for shifting a wheelchair lift within a vehicle, the mounting plate includes at least one channel. The at least one guiding rail is arranged in the at least one channel. The at least one guiding rail can be recessed in the channel of the mounting plate and therefore does not protrude from the mounting plate. For its part, the channel acts as a guide that holds the at least one sliding element securely on the at least one guiding rail during a translational movement of the supporting plate or the wheelchair lift.

According to a possible embodiment of the arrangement for shifting a wheelchair lift within a vehicle, the at least one guiding rail has a rail support mounted to the mounting plate and a rail head disposed above the rail support. The rail support can be mounted to a bottom side of the at least one channel. According to a possible embodiment, the rail head can be shaped in such a way that it enables the sliding element to be held securely on the at least one guiding rail.

The at least one sliding element can be formed to engage the rail head so that the at least one sliding element is secured to be stable against tilting. The configuration of the at least one guiding rail with the rail head and the configuration of the at least one sliding element thus ensure that the supporting plate is held securely on the at least one guiding rail and is safely guided along the at least one guiding rail.

The engagement of the at least one sliding element in the rail head creates a secure anchorage between the at least one guiding rail and the at least one sliding element or the supporting plate. This is important as high forces act on the supporting plate when the platform of the wheelchair lift is in the extended position and is moved by the lifting device of the wheelchair lift between the ground position and the entry position. The engagement of the at least one sliding element and the rail head of the at least one guiding rail ensures that the supporting plate, and therefore the wheelchair lift, is not lifted off the at least one guiding rail during a lowering or lifting movement of the platform of the wheelchair lift.

According to a possible embodiment of the arrangement for shifting a wheelchair lift within a vehicle, the at least one sliding element has a guiding channel that engages the rail head of the at least one guiding rail.

According to a possible embodiment, the guiding channel is lined with a plastic material so that the rail head of the at least one guiding rail is in contact with the plastic material. Due to the lining of the guiding channel, the at least one sliding element slides with a plastic material on the at least one guiding rail or rail head. The movement of the at least one sliding element along the at least one guiding rail is therefore low-friction and nearly wear-free, without the need for a lubricant.

According to a possible embodiment, the arrangement for shifting a wheelchair lift within a vehicle comprises a drive unit for moving the supporting plate in a moving direction along the at least one guiding rail. The drive unit enables automatic movement of the supporting plate and thus of the wheelchair lift mounted on it.

According to a possible embodiment of the arrangement for shifting a wheelchair lift within a vehicle, the drive unit may comprise a motor and a threaded spindle. The motor is mechanically coupled to the threaded spindle so that the motor can set the threaded spindle in a rotational movement. The threaded spindle is mechanically coupled to the supporting plate, for example by a spindle nut, to move the supporting plate in the moving direction along the at least one guiding rail. The spindle nut can be mounted on a bottom side of the supporting plate.

Depending on the pitch of the threaded spindle, the supporting plate and therefore the wheelchair lift mounted on it can be moved slowly and therefore precisely from the parking position to the exit/entry position at the vehicle entrance area, for example near a side door of the vehicle. The motor can be activated, for example, by a switch or a remote control for example, so that a disabled person can move the wheelchair lift to a suitable position themselves if necessary.

According to a possible embodiment of the arrangement for shifting a wheelchair lift within a vehicle, the mounting plate includes a cavity which is configured for receiving the threaded spindle. The cavity is configured in such a way that the spindle nut sitting on the threaded spindle is also arranged in the cavity. The supporting plate therefore slides with its underside on the upper side of the mounting plate.

The threaded spindle is protected from dirt by its arrangement in the cavity of the mounting plate. On the other hand, this also prevents contamination at a lubricant of the threaded spindle.

An embodiment of a shiftable lifting assembly for disabled persons is provided according to another aspect of the invention.

According to the proposed approach, the shiftable lifting assembly comprises a wheelchair lift and an arrangement for shifting the wheelchair lift according to one of the embodiments described above. The wheelchair lift is mounted on the arrangement for shifting the wheelchair lift so that the supporting plate supports the wheelchair lift. In particular, the arrangement for shifting the wheelchair lift may comprise a mounting rack/frame that is mounted on a top side of the supporting plate. The mounting rack/frame is configured for mounting the wheelchair lift to the mounting rack/frame and thus to the supporting plate.

Additional features and advantages of the proposed arrangement for shifting a wheelchair lift within a vehicle and a shiftable lifting assembly are set forth in the detailed description that follows. It is to be understood that both the foregoing general description and the following detailed description are merely exemplary, and are intended to provide an overview or framework for understanding the nature and character of the claims.

### BRIEF DESCRIPTION OF THE DRAWINGS

The accompanying drawings are included to provide further understanding, and are incorporated in, and constitute a part of, the specification. As such, the disclosure will be more fully understood from the following detailed description, taken in conjunction with the accompanying figures in which:

FIG. 1 shows a shiftable lifting assembly for disabled persons comprising an arrangement for shifting a wheelchair lift and a wheelchair lift mounted on the arrangement and moved to a first position;

FIG. 2 shows a shiftable lifting assembly for disabled persons comprising an arrangement for shifting a wheelchair lift and a wheelchair lift mounted on the arrangement and moved in a second position;

FIG. 3 shows a perspective view of an arrangement for shifting a wheelchair lift within a vehicle;

FIG. 4 shows a cross-sectional view of an arrangement for shifting a wheelchair lift within a vehicle;

FIG. 5A shows a cross-sectional view of a mounting plate of an arrangement for shifting a wheelchair lift within a vehicle with a guiding rail mounted in a channel of the mounting plate;

FIG. 5B shows a perspective view of a mounting plate of an arrangement for shifting a wheelchair lift within a vehicle with a guiding rail mounted in a channel of the mounting plate;

FIG. 6 shows a perspective view of a supporting plate of an arrangement for shifting a wheelchair lift within a vehicle comprising sliding elements mounted on a bottom side of the supporting plate and a wheelchair lift mounted on a top side of the supporting plate;

FIG. 7A shows a cross-sectional view of a sliding element mounted on a bottom side of a supporting plate for supporting a wheelchair lift;

FIG. 7B shows a perspective view of a sliding element mounted on a bottom side of a supporting plate for supporting a wheelchair lift;

FIG. 8 shows a cross-sectional view of a sliding element comprising a guiding channel which engages a rail head of a guiding rail;

FIG. 9 shows a drive unit of an arrangement for shifting a wheelchair lift comprising a motor and a threaded spindle;

FIG. 10 shows a threaded spindle arranged in a cavity of a mounting plate of an arrangement for shifting a wheelchair lift;

FIG. 11 shows a cross-sectional view of a spindle nut mounted on a bottom side of a supporting plate and sitting on a threaded spindle of a drive unit of an arrangement for shifting a wheelchair lift; and

FIG. 12 shows a perspective view of a shiftable lifting assembly for disabled persons comprising a drive unit for moving a wheelchair lift mounted on a supporting plate of an arrangement for shifting a wheelchair lift.

### DETAILED DESCRIPTION

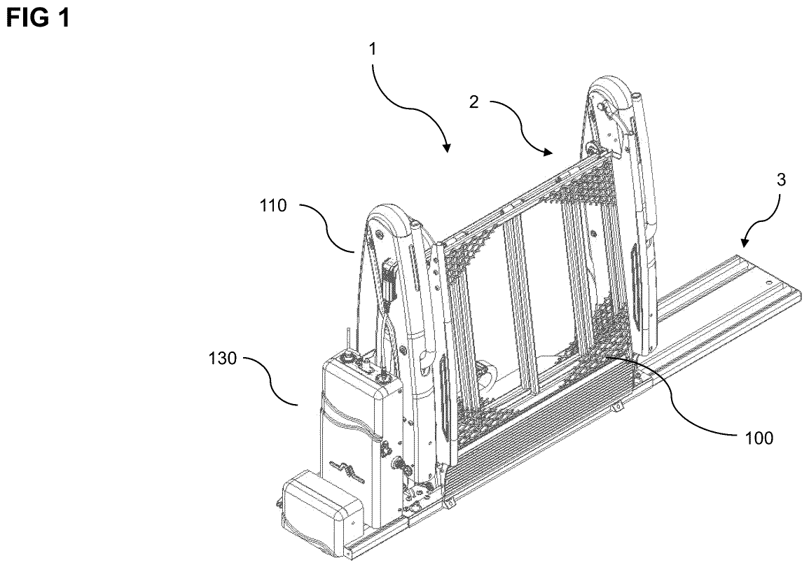

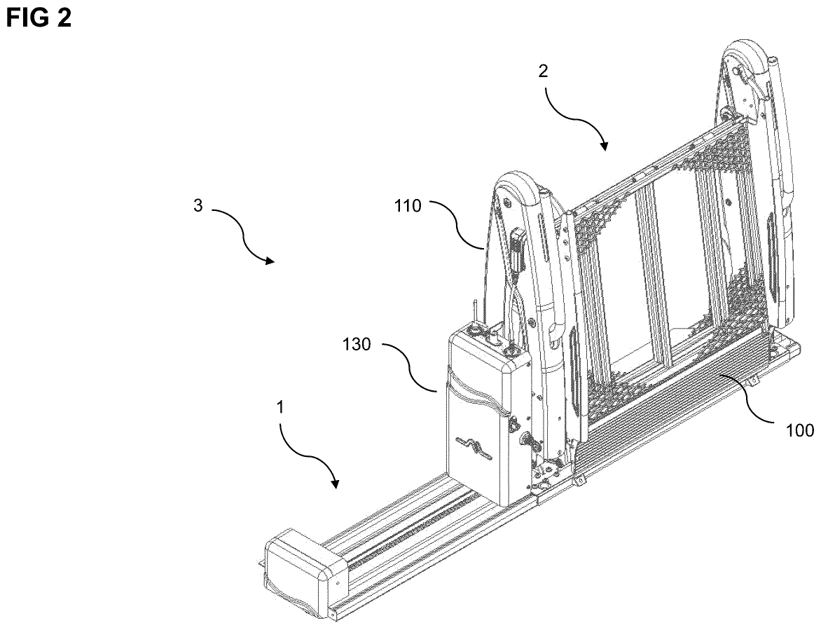

FIGS. 1 and 2 show an embodiment of a shiftable lifting assembly 1 for disabled persons which comprises a wheelchair lift 2 and an arrangement 3 for shifting the wheelchair lift within a vehicle. The shiftable lifting assembly 1 enables the wheelchair lift 2 to be moved from a first position shown in FIG. 1 to a second position, as shown in FIG. 2.

The wheelchair lift 2 may comprise a platform assembly 100 for loading a wheelchair, lifting arms 110 for raising and lowering the platform assembly, and an electric or hydraulic drive system 130 for moving the lifting arms 110 and the platform assembly 100. The platform assembly 100 can be moved from a retracted or stowed position in which the platform and the lifting arms are collapsed and which is shown in FIGS. 1 and 2, to an entry position at the vehicle floor level and further to a ground position in which the platform assembly touches the ground below the vehicle with the aid of the lifting arms. When moving from the retracted/stowed position to the entry or ground position, the platform assembly folds out so that the platform assembly can be loaded with a wheelchair or the wheelchair can be unloaded from the platform assembly, when the platform assembled reached the entry or ground position.

The wheelchair lift 2 shown in FIGS. 1 and 2 can, for example, be embodied as a two-armed lift or a dual-arm lift.

In principle, the shiftable lifting assembly 1 may comprise other configurations of wheelchair lifts or the arrangement 1 for moving the wheelchair lift 2 can be used for shifting other configurations of wheelchair lifts, for example for shifting single-arm lifts which use only one lifting arm for raising and lowering the platform assembly.

For example, the shiftable lifting assembly 1 can be mounted in a vehicle to shift the wheelchair 2 within the vehicle between a parking position, for example the position shown in FIG. 1, and an entry/exit position, for example the position shown in FIG. 2. If a disabled person sitting in a wheelchair wants to get into or out of the vehicle, the wheelchair lift can be moved by the arrangement 3 for shifting the wheelchair from the parking position to the entry/exit position, when the wheelchair lift 2 is in the retracted position.

The shiftable lifting assembly 1 is configured for mounting onto a floor of the vehicle, for example near a sidewall of the vehicle, so that the wheelchair lift is located in the rear area of the vehicle, when the wheelchair lift is moved to the first/parking position shown in FIG. 1, and near an entrance door, for example a side access door of the vehicle, when the wheelchair lift 2 is moved to the second position or the entry/exit position in the entrance area of the vehicle shown in FIG. 2.

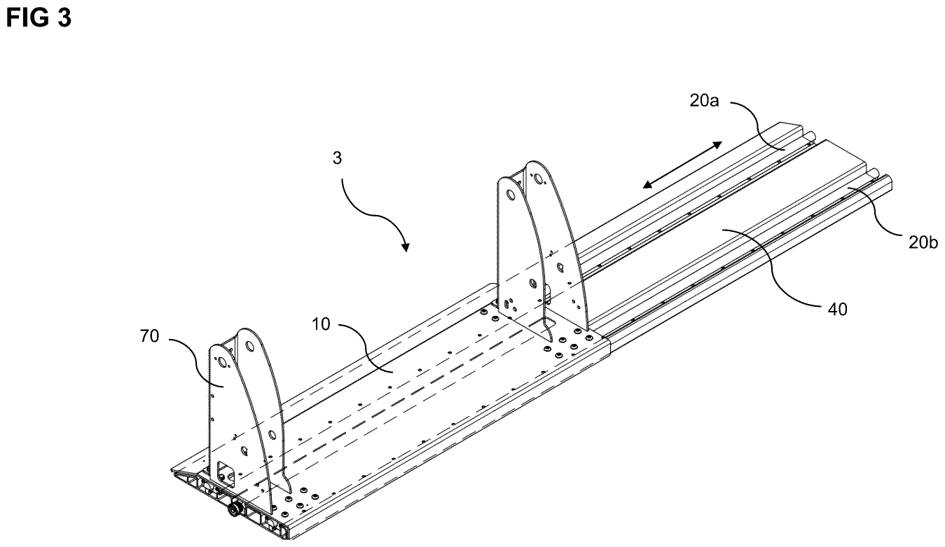

Embodiments of the arrangement 3 for shifting the wheelchair lift 2 within a vehicle are described in more detail in the following FIGS. 3 to 13.

FIG. 3 shows the arrangement 3 for shifting a wheelchair within a vehicle in a perspective view. The arrangement 3 comprises a supporting plate 10 for supporting the wheelchair lift. According to a possible embodiment of the shiftable lifting assembly 1, the the supporting plate 10 of the arrangement 3 serves as a base plate for the wheelchair lift over which a wheelchair can roll from the platform into the interior of the vehicle or over which the wheelchair can roll from the interior of the vehicle onto the platform of the wheelchair lift. According to another possible embodiment, the wheelchair lift may comprise a base plate being different from the support plate 10.

The arrangement 3 further comprises a mounting rack/frame 70 mounted on a top side of the supporting plate 10. The mounting rack/frame 70 is configured for mounting the wheelchair lift to the mounting rack/frame 70 and thus to the supporting plate 10. As illustrated in the example shown in FIGS. 1 and 2, the lifting arms 110 of the wheelchair lift 2 can be mounted to the mounting rack/frame 70 for mounting the wheelchair lift to the arrangement 3.

The arrangement 3 for shifting a wheelchair lift within a vehicle further comprises at least one guiding rail 20a, 20b along which the supporting plate 10 and thus the wheelchair lift mounted on it can be moved in a moving direction indicated by a double arrow in FIG. 3.

The arrangement 3 for shifting a wheelchair lift within a vehicle further comprises a mounting plate 40 being configured to be mounted with a bottom side to a floor of the vehicle. The mounting plate 40 can, for example, be bolted to the vehicle floor or if this is not possible, particularly in the case of vehicles with an electric drive system in which the battery is often located under the vehicle floor, its underside can be glued to the vehicle floor.

FIG. 3 shows an embodiment of the arrangement 3 for shifting a wheelchair lift within a vehicle comprising a guiding rail 20a and a guiding rail 20b that are attached to the mounting plate 40 at a distance from each other. The two guiding rails 20a and 20b enable a stable hold of the supporting plate 10 and secure guidance of the supporting plate 10 and the wheelchair lift mounted on it during the movement of the supporting plate 10 in the moving direction along the guiding rails 20a and 20b.

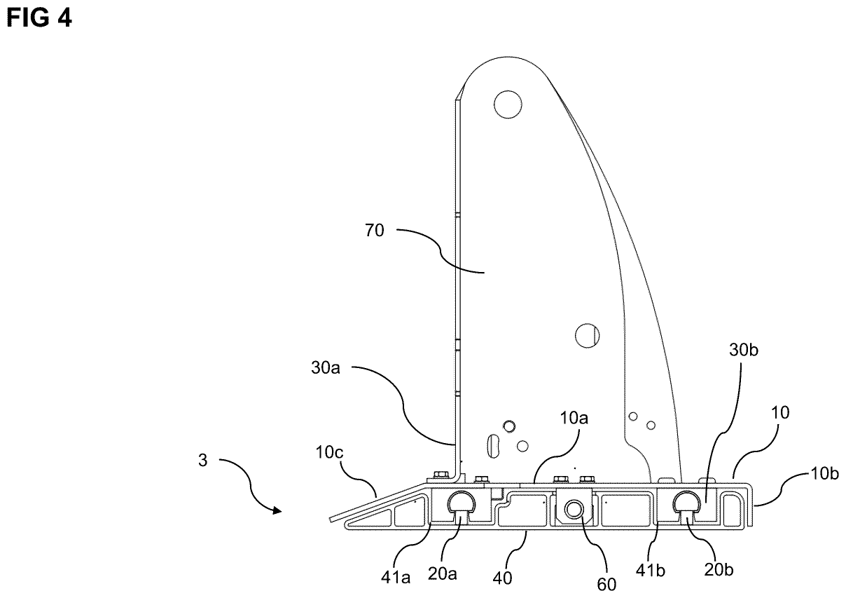

Further details of the embodiment of the arrangement 3 for shifting a wheelchair lift within a vehicle are explained below with reference to FIG. 4, which shows a cross-sectional view of the shifting arrangement 3. The arrangement 3 for shifting a wheelchair lift comprises at least one sliding element 30a, 30b being configured to be secured on the at least one guiding rail 20a, 20b and to be movable along the at least one guiding rail. The at least one sliding element 30a, 30b is arranged on a bottom side of the supporting plate 10, wherein the bottom side of the supporting plate 10 faces the at least one guiding rail 20a, 20b. The at least one sliding element 30a, 30b is embodied as a carriage that is configured to slide on the at least one guiding rail 20a, 20b. In interaction with the at least one guiding rail 20a, 20b, the at least one sliding element 30a, 30b enables the movement of the supporting plate 10 and thus the movement of the wheelchair lift mounted on the rack/frame 70. FIG. 4 shows the mounting rack/frame 70 being mounted on a top side of the supporting plate 10.

The mounting plate 40 includes at least one channel 41a, 41b. The at least one guiding rail 20a, 20b is arranged in the at least one channel 41a, 41b. The at least one channel 41a, 41b enables the at least one sliding element 30a, 30b to be moved safely and stably along the at least one guiding rail 20a, 20b.

FIG. 4 shows an embodiment of the arrangement 3 for shifting a wheelchair lift in which two guiding rails 20a, 20b are arranged on the mounting plate 40. The mounting plate 40 includes a channel 41a in which the guiding rail 20a is arranged, and a channel 41b in which the guiding rail 20b is arranged. Accordingly, the arrangement 3 has a sliding element 30a, which is configured to slide on the guiding rail 20a in the channel 41a, and a further sliding element 30b, which is configured to slide on the guiding rail 20b in the channel 41b.

Referring to FIG. 4, the supporting plate 10 has a region 10a which is arranged on the top side of the mounting plate 40. Lateral regions 10b of the supporting plate 10 may be bent around side walls of the mounting plate 40 on one side or both sides of the mounting plate 40. According to another possible embodiment, one of the side walls of the mounting plate is bevelled, as illustrated in FIG. 3. According to such an embodiment of the arrangement 3, only one of the lateral regions 10b of the supporting plate 10 is bent around one of the side walls of the mounting plate. On the other side of the mounting plate 40, where the mounting plate is bevelled, a region 10c of the supporting plate 10 extends along the bevelled upper side of the mounting plate 40 and is thus bevelled with respect to the region 10a of the supporting plate 10.

The region 10b of the supporting plate 10, which is angled in relation to the region 10a, and the region 10c of the supporting plate 10, which is bevelled in relation to the region 10a, keep the supporting plate 10 stable on the mounting plate 40 in addition to the fixation via the sliding elements 30a, 30b and the guiding rails 20a, 20b.

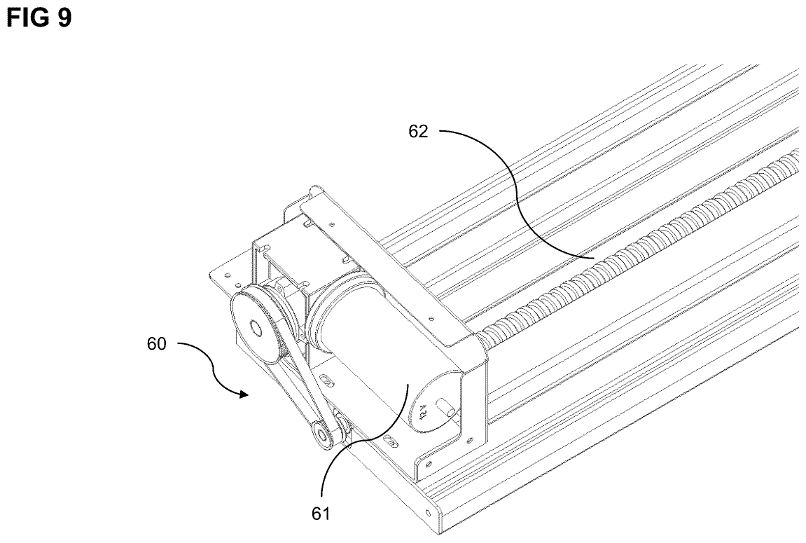

FIG. 4 also shows part of a drive unit 60 for moving the supporting plate 10. Possible embodiments of the drive unit 60 are explained in more detail below with reference to FIGS. 9 to 12.

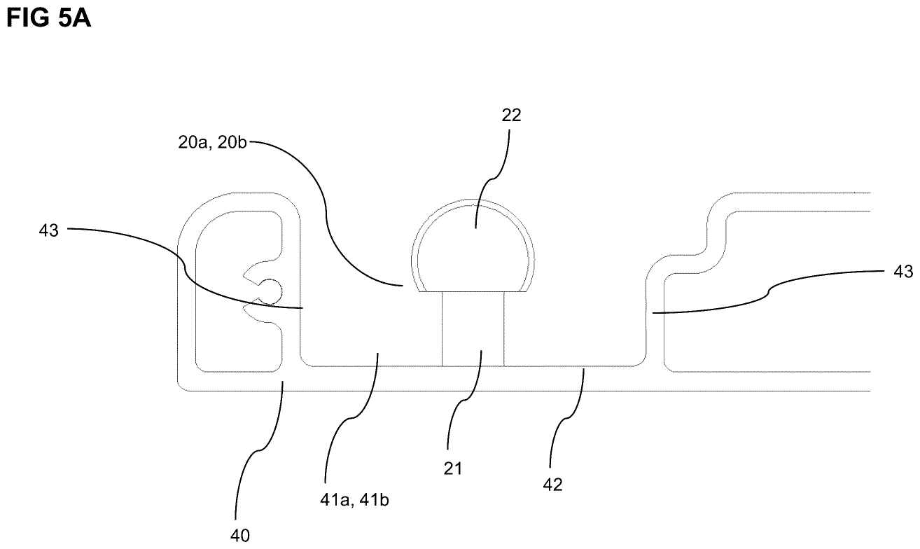

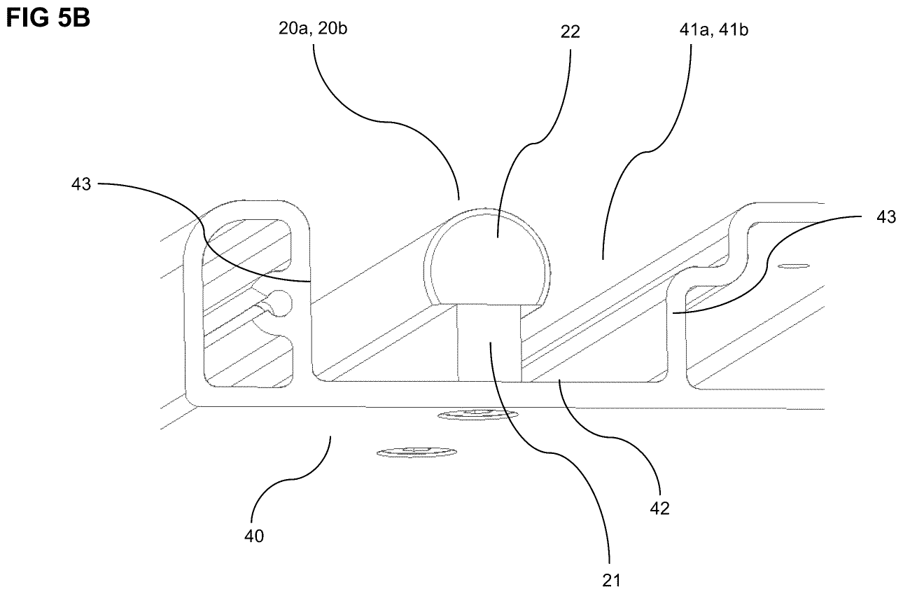

An embodiment of the mounting plate 40 including at least one channel 41a, 41b and an embodiment of the at least one guiding rail 20a, 20b which is mounted in the at least one channel 41a, 41b to the mounting plate 40 are shown in the cross-sectional view of the mounting plate 40 and the at least one guiding rail 20a, 20b of FIG. 5A and the perspective view of the mounting plate 40 and the at least one guiding rail 20a, 20b shown in FIG. 5B.

The at least one channel 41a, 41b has a bottom wall 42 and sidewalls 43. The at least one guiding rail 20a, 20b is mounted to the bottom wall 42 of the at least one channel 41a, 41b. The at least one guiding rail 20a, 20b is arranged in the at least one channel 41a, 41b spaced from the sidewalls 43.

Referring to FIGS. 5A and 5B, according to a possible embodiment of the arrangement for shifting a wheelchair lift, the at least one guiding rail 20a, 20b has a rail support 21 and a rail head 22. The rail support 21 is mounted to the mounting plate 40, i.e. to the bottom wall 42 of the at least one channel 41a, 41b of the mounting plate 40. The rail head 22 is disposed above the rail support 21. As illustrated in FIGS. 5A and 5B, the rail support 21 and the rail head 22 of the at least one guiding rail 20a, 20b can be arranged such that the at least one guiding rail 20a, 20b is mushroom-shaped. In particular, the rail head 22 can have a spherical or hemispherical cross-section, for example a D-shaped cross-section. This special design of the at least one guiding rail 20a, 20b enables the at least one sliding element 30a, 30b to be held securely on the rail head 22.

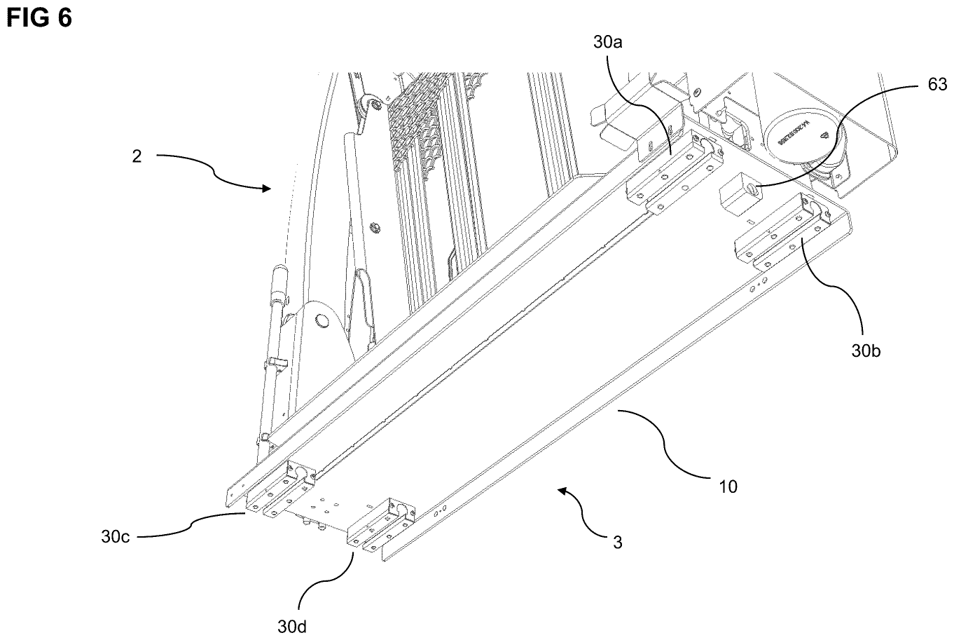

FIG. 6 shows a perspective view of a part of the arrangement 3 for shifting a wheelchair lift 2. The arrangement 3 comprises four of the at least one sliding element, i.e. a sliding element 30a, a sliding element 30b, a sliding element 30c, and a sliding element 30d which are arranged on the bottom side of the supporting plate 10.

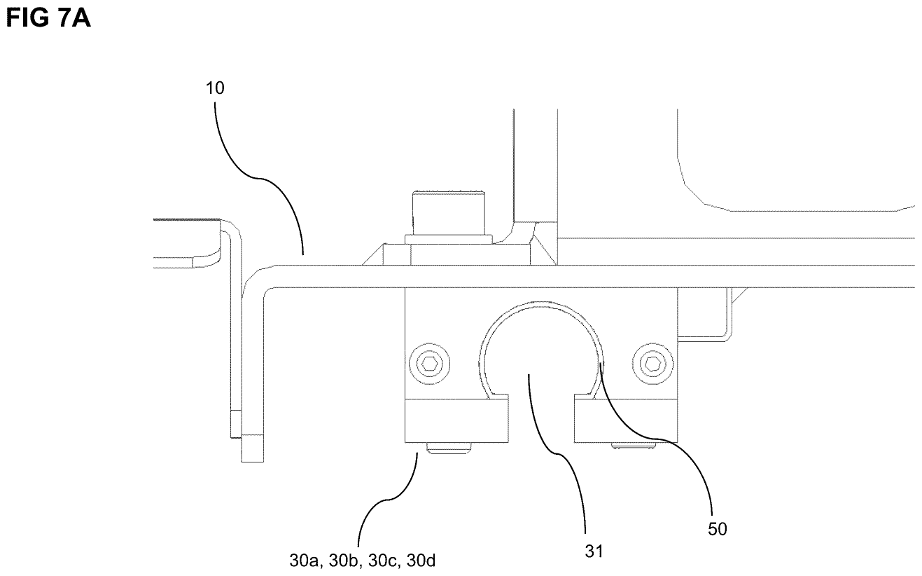

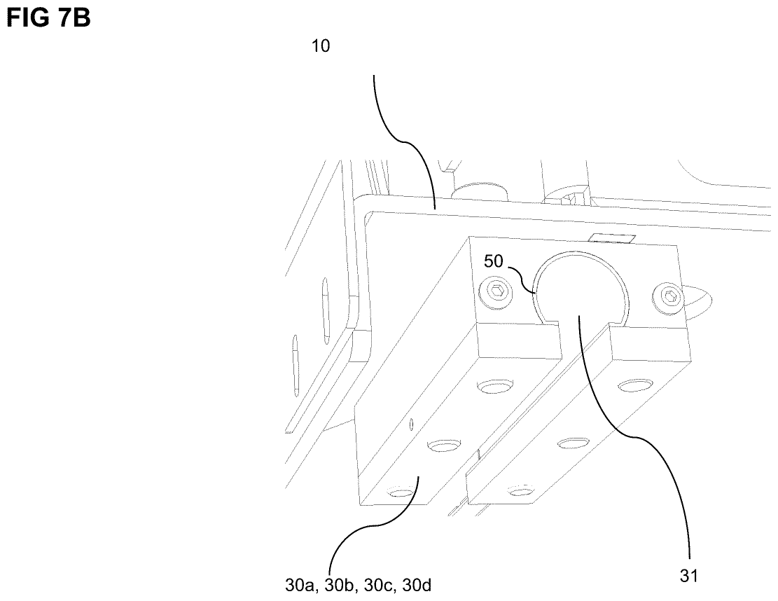

Possible embodiments of the at least one sliding element 30a, 30b, 30c, 30d are explained with reference to FIG. 7A that shows a cross-sectional view of the at least one sliding element 30a, 30b, 30c, 30d mounted to the bottom side of the supporting plate 10, and FIG. 7B which shows a perspective view of the at least one sliding element 30a, 30b, 30c, 30d mounted to the bottom side of the supporting plate 10. According to the embodiment shown in FIGS. 7A and 7B, the at least one sliding element 30a, 30b, 30c, 30d has a guiding channel 31. The guiding channel 31 is configured such that the at least one sliding element 30a, 30b, 30c, 30d engages with the at least one guiding rail 20a, 20b.

According to a possible embodiment of the arrangement for shifting a wheelchair lift, the guiding channel 31 of the at least one sliding element 30a, 30b, 30c, 30d is lined with a plastic material 50 so that the rail head 22 is in contact with the plastic material 50, when the at least one sliding element engages with the rail head 22 of the at least one guiding rail 20a, 20b.

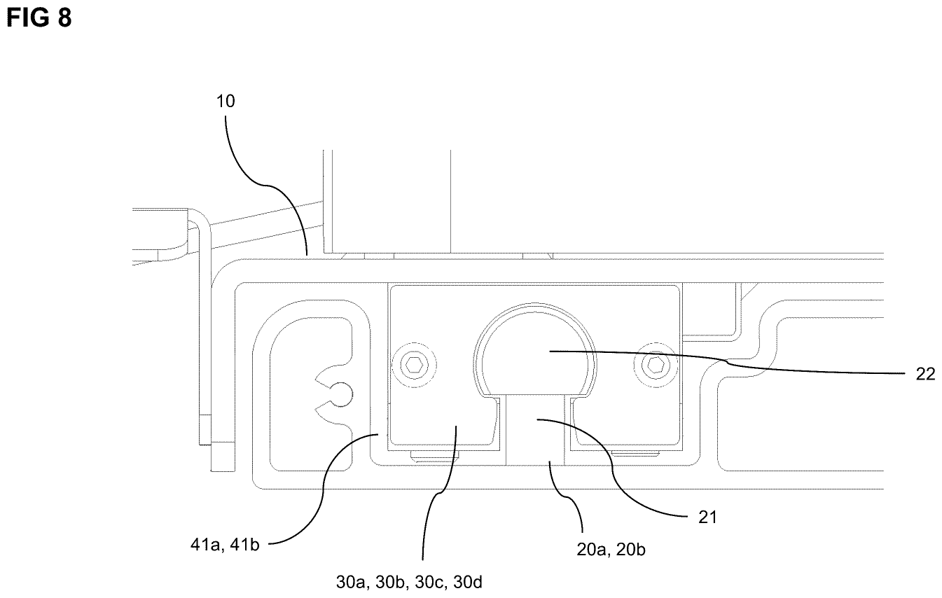

FIG. 8 shows the at least one sliding element 30a, 30b, 30c, 30d mounted on a bottom side of the supporting plate 10. The at least one sliding element 30a, 30b, 30c, 30d is further mounted on the at least one guiding rail 20a, 20b, with the rail head 22 engaging with a form fit in the guiding channel 31 of the at least one sliding element 30a, 30b, 30c, 30d. For this purpose, the rail head 22 and the guiding channel 31 are shaped to complement each other.

The proposed complementary shape of the rail head 22 and the guiding channel 31 enables that the at least one sliding element 30a, 30b, 30c, 30d engages with the rail head 22 of the at least one guiding rail 20a, 20b in a way that the at least one sliding element 30a, 30b, 30c, 30d is secured to be stable against tilting. This ensures that the supporting plate 10 is held securely on the guiding rails 20a, 20b when the platform assembly of the wheelchair lift is deployed or loaded with a wheelchair.

As shown in FIG. 8, the rail head 22 of the at least one guiding rail 20a, 20b is in contact with the plastic material 50 so that the material lining of the guiding channel 31 slides on the rail head 22, when the supporting plate 10 is moved along the at least one guiding rail 20a, 20b. As a result, the movement of the supporting plate 10 and the wheelchair lift mounted on it is nearly maintenance- and abrasion-free without the need for a lubricant between the rail head 22 and the at least one sliding element 30a, 30b, 30c, 30d.

FIGS. 9 to 12 show an embodiment of a drive unit 60 for moving the supporting plate 10 in the moving direction along the at least one guiding rail 20a, 20b.

Referring to FIG. 9, the drive unit 60 comprises a motor 61 and a threaded spindle 62. The motor 61 is mechanically coupled to the threaded spindle 62 to drive the threaded spindle so that the threaded spindle is set in a rotational movement. The threaded spindle 62 is mechanically coupled to the supporting plate to move the supporting plate in the moving direction.

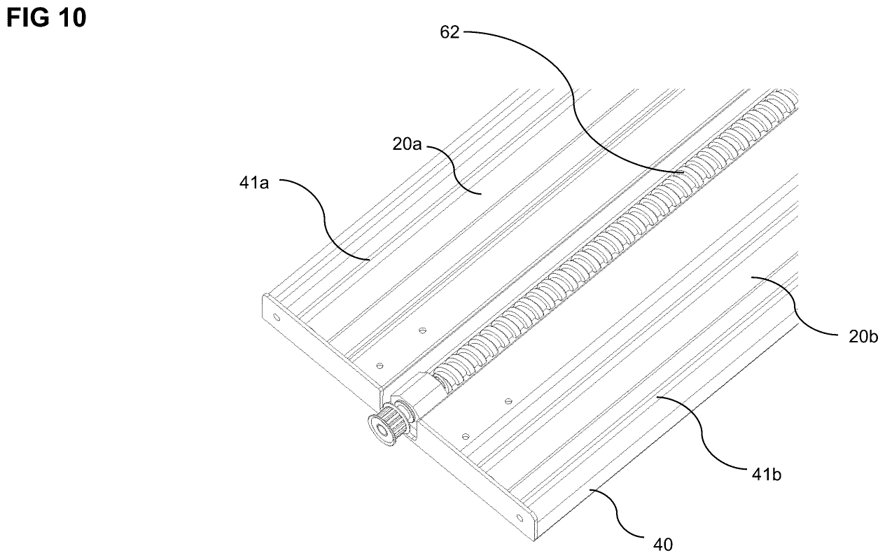

Referring to FIG. 10, the mounting plate 40 includes a channel 41a in which the guiding rail 20a is arranged, and a channel 41b in which the guiding rail 20b is arranged. The channel 41a is arranged at a distance to the channel 41b. The mounting plate 10 includes a cavity 12 being arranged between the channel 41a and the channel 41b. The threaded spindle 62 is arranged in the cavity 12 of the mounting plate 40.

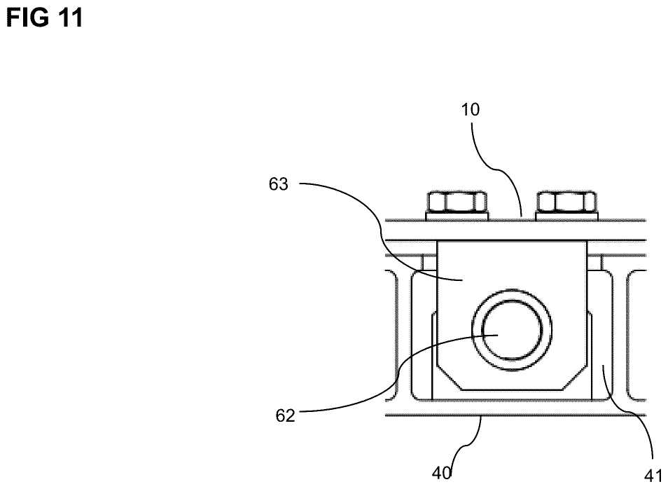

Referring to FIGS. 6 and 11, the drive unit 60 comprises a spindle nut 63 being mounted on the bottom side of the supporting plate 10. The spindle nut 63 is mechanically coupled to the threaded spindle 62 which is located in the channel 41 of the mounting plate 40 so that the supporting plate 10 is set into a translatory movement in the moving direction by the rotational movement of the threaded spindle 62.

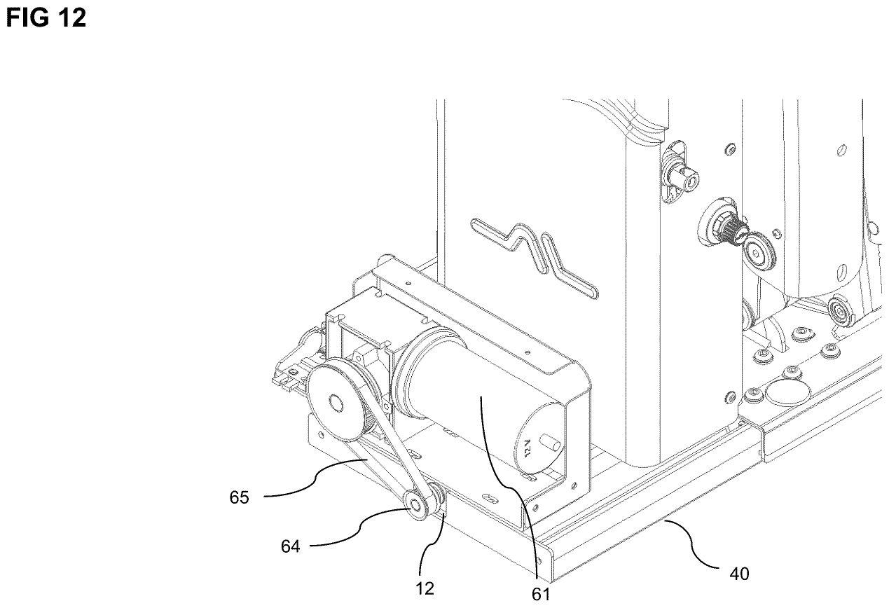

Referring to FIG. 12, the drive unit 60 comprises a gear wheel 64 arranged at an end of the threaded spindle 62. The gear wheel 64 protrudes out of the cavity 12 of the mounting plate 40. The drive unit 60 further comprises a toothed belt 65. The gear wheel 64 is coupled to the motor 61 via the toothed belt 65 in such a way that the threaded spindle 62 is set in the rotational movement by the toothed belt 65 and via the gear wheel 64 when the motor 61 is running.

The spindle drive mechanism shown in FIGS. 9 to 12 enables a slow and constant speed when moving the wheelchair lift 2 by the shifting arrangement 3. In addition, the wheelchair lift can be precisely positioned by the shifting arrangement 3 from the parking position to the exit/entry position in the entrance area of a vehicle.

It should be noted that the drive unit based on a spindle drive described in FIGS. 9 to 12 is only one of many options for moving the supporting plate and the wheelchair lift and that the proposed arrangement for shifting a wheelchair lift within a vehicle or the shiftable lifting assembly are not limited to this type of drive. For example, the supporting plate can be moved by means of a rack and pinion drive or by means of a hydraulic drive, to name just two other possible drive types.

The embodiments of the proposed arrangement for shifting a wheelchair lift within a vehicle and the shiftable lifting assembly for disabled persons disclosed herein have been discussed for the purpose of familiarizing the reader with novel aspects of the arrangement for shifting a wheelchair lift and the shiftable lifting assembly. Although preferred embodiments have been shown and described, many changes, modifications, equivalents and substitutions of the disclosed concepts may be made by one having skill in the art without unnecessarily departing from the scope of the claims.

In particular, the design of the proposed arrangement for shifting a wheelchair lift and the shiftable lifting assembly is not limited to the disclosed embodiments, and gives examples of many alternatives as possible for the features included in the embodiments discussed. However, it is intended that any modifications, equivalents and substitutions of the disclosed concepts be included within the scope of the claims which are appended hereto.

Features recited in separate dependent claims may be advantageously combined. Moreover, reference signs used in the claims are not limited to be construed as limiting the scope of the claims.

Furthermore, as used herein, the term “comprising” does not exclude other elements. In addition, as used herein, the article “a” is intended to include one or more than one component or element, and is not limited to be construed as meaning only one.

What is claimed is:

1. An arrangement for shifting a wheelchair lift within a vehicle, comprising:
a supporting plate (10) for supporting the wheelchair lift (2),
at least one guiding rail (20a, 20b),
at least one sliding element (30a, 30b, 30c, 30d) being configured to be secured on the at least one guiding rail (20a, 20b) and to be movable along the at least one guiding rail (20a, 20b),
wherein the at least one sliding element (30a, 30b, 30c, 30d) is arranged on a bottom side of the supporting plate (10), the bottom side of the supporting plate (10) facing the at least one guiding rail (20a, 20b).

2. The arrangement of claim 1, comprising:
a mounting plate (40) being configured to be mounted with a bottom side to a floor of the vehicle,
wherein the at least one guiding rail (20a, 20b) is mounted to a top side of the mounting plate (40).

3. The arrangement of claim 2,
wherein the mounting plate (40) includes at least one channel (41a, 41b),
wherein the at least one guiding rail (20a, 20b) is arranged in the at least one channel (41a, 41b).

4. The arrangement of claim 3,
wherein the at least one channel (41a, 41b) has a bottom wall (42) and side walls (43),
wherein the at least one guiding rail (20a, 20b) is mounted to the bottom wall (42) of the at least one channel (41a, 41b) and is arranged in the at least one channel (41a, 41b) spaced from the side walls (43).

5. The arrangement of claim 4,
wherein the at least one guiding rail (20a, 20b) has a rail support (21) mounted to the mounting plate (40) and a rail head (22) disposed above the rail support (21).

6. The arrangement of claim 5,
wherein the at least one sliding element (30a, 30b, 30c, 30d) is formed to engage the rail head (22) so that the at least one sliding element (30a, 30b, 30c, 30d) is secured to be stable against tilting.

7. The arrangement of claim 5,
wherein the at least one sliding element (30a, 30b, 30c, 30d) has a guiding channel (31),
wherein the guiding channel (31) and the rail head (22) are formed so that the rail head (22) engages the guiding channel (31).

8. The arrangement of claim 7,
wherein the guiding channel (31) is lined with a plastic material (50) so that the rail head (22) is in contact with the plastic material (50).

9. The arrangement of claim 1, comprising:
a drive unit (60) for moving the supporting plate (10) in a moving direction along the at least one guiding rail (20a, 20b).

10. The arrangement of claim 3,
wherein the drive unit (60) comprises a motor (61) and a threaded spindle (62),
wherein the motor (61) is mechanically coupled to the threaded spindle (62) to drive the threaded spindle so that the threaded spindle is set in a rotational movement,
wherein the threaded spindle (62) is mechanically coupled to the supporting plate (10) to move the supporting plate in the moving direction.

11. The arrangement of claim 10,
wherein the drive unit (60) comprises a spindle nut (63) being mounted on the bottom side of the supporting plate (10),
wherein the spindle nut (63) is mechanically coupled to the threaded spindle (62) so that the supporting plate (10) is set into a translatory movement in the moving direction by the rotational movement of the threaded spindle (62).

12. The arrangement of claim 11,
wherein the drive unit (60) comprises a gear wheel (64) arranged at an end of the threaded spindle (62),
wherein the drive unit (60) comprises a toothed belt (65),
wherein the gear wheel (64) is coupled to the motor (61) via the toothed belt (65) in such a way that the threaded spindle (62) is set in the rotational movement by the toothed belt (65) and via the gear wheel (64) when the motor (61) is running.

13. The arrangement of claim 10, comprising:
a first one of the at least one guiding rail (20a) and a second one of the at least one guiding rail (20b),
wherein the mounting plate (40) includes a first one of the at least one channel (41a) and a second one of the at least one channel (41b), the first channel (41a) being arranged in a distance to the second channel (41b),
wherein the first guiding rail (20a) is arranged in the first channel (41a) and the second guiding rail (20b) is arranged in the second channel (41b),
wherein the mounting plate (10) includes a cavity (12) being arranged between the first channel (41a) and the second channel (41b),
wherein the threaded spindle (62) is arranged in the cavity (12) of the mounting plate (40).

14. The arrangement of claim 1, comprising:
a mounting rack (70) mounted on a top side of the supporting plate (10),
wherein the mounting rack (70) is configured for mounting a wheelchair lift (2) to the mounting rack (70).

15. A shiftable lifting assembly for disabled persons, comprising:
a wheelchair lift (2),
the arrangement (3) for shifting the wheelchair lift (2) according to claim 1,
wherein the wheelchair lift (2) is mounted on the arrangement (3) for shifting the wheelchair lift so that the supporting plate (10) supports the wheelchair lift (2).
